(19) United States
(12) Patent Application Publication
(10) Pub. No.: US 2012/0238264 A1
(43) Pub. Date: Sep. 20, 2012

(54) METHOD AND APPARATUS TO SUPPORT SEAMLESS MOBILITY ACROSS OFFLOAD GATEWAYS

(75) Inventor: Tamanna Jindal, Bangalore (IN)

(73) Assignee: STOKE, INC., Santa Clara, CA (US)

(21) Appl. No.: 13/051,775

(22) Filed: Mar. 18, 2011

(51) Int. Cl. H04W 36/08

(52) U.S. Cl. 455/432.1; 455/438

(57) ABSTRACT

A method is described that involves performing the following at an offload network gateway: receiving a RELOCATION_REQUIRED message from an RNC; recognizing that the RELOCATION_{—} REQUIRED message pertains to a roaming device having a live session with a network that the offload network gateway acts as a gateway to in order to offload data traffic from the GPRS network; and, adding information specific to the session to the RELOCATION_{—} REQUIRED message. A method is also described that includes performing the following at an offload network gateway: receiving a RELOCATION _REQUEST message; inspecting the RELOCATION_REQUEST message for information specific to a roaming device's live session with a network that the offload network gateway acts as a gateway to in order to offload data traffic from a GPRS network; and, in response to identifying the information within the RELOCATION_{—} REQUEST message, extracting the information and using the information to continue the session for the roaming device.

### FIELD OF INVENTION

The field of invention relates generally to networking, and, more specifically, to a method and apparatus to support seamless mobility across offload gateways.

### BACKGROUND

With the emergence of mobile computing, wireless network service providers are faced with the challenge of providing continuous service to a mobile device as the device changes its position from location to location. Here, a mobile device may include various mobile computing systems such as a laptop, netbook or tablet computing system or a handheld computing system such as a smartphone, cellphone or other such device. FIG. 1 shows a traditional 3G wireless network 100 and a 3G Partnership Project (3GPP) methodology for providing continuous service to a roaming mobile device.

The traditional 3G network 100 of FIG. 1 includes a General Packet Radio Service (GPRS) core network 101. The GPRS core network 101 typically provides mobility management, session management and transport services for its underlying wireless network(s). As observed in FIG. 1, the GPRS core network 101 includes a number of communicatively coupled Serving GPRS Support Nodes (SGSNs) 102_1, . . . 102_N. An SGSN is responsible for a specific region of the overall geographic region that the GPRS core 101 is designed to provide services for. The GPRS network 101 is also observed to include a Gateway GPRS Support Node (GGSN) 103. A GGSN 103 acts as the GPRS core's gateway to some other (possibly wide area) network (such as the Internet) 104.

As observed in FIG. 1, each SGSN may be coupled to one or more radio network controllers (RNCs). For instance, SGSN 102_1 is coupled to RNC 105_1 and RNC 105_2. An RNC acts as control equipment for one or more base stations 106_1, . . . 106_N. Each base station (also referred to as “Node B”) essentially acts as the air medium access node to the service provider's network within a specific region of the geographic region that a particular SGSN is responsible for.

In the case of the standard 3GPP roaming methodology, when a mobile computing system 107 changes locations supported by different RNCs, the RNC 105_2 of the region 108 that the roaming device has departed (the “source RNC”) sends a RELOCATION_REQUIRED message 1 to the GPRS core network 101. The RELOCATION REQUIRED message 1 essentially notifies the GPRS network 101 that a mobile device is leaving a region and needs to be associated with another region. Because a mobile device typically moves to a neighboring region 109, the source RNC 105_2 can determine the identity of the (“target”) RNC 105_3 for the region that the mobile device is roaming into. As such, according to the 3GPP mobility algorithm, the RELOCATION_REQUIRED message 1 also includes the identity of the target RNC 105_3. The RELOCATION_REQUIRED message 1 also includes information (within an “RRC container”) that is used by the target RNC 105_3 to provide seamless mobility to the end user as the service provider switches management of the user's session to the newly entered region. Here, as is known the art, a session is a communication flow through a network between a particular set of endpoints. For instance, the mobile device might be engaged in two different sessions if two different applications on the mobile device were respectively engaged with two different network sites. 3G networks recognize a “primary PDP context” for each session, and, each primary PDP context can have an associated “secondary PDP context”, where, different QoS parameters are associated between the primary and secondary PDP contexts.

With knowledge of the target RNC 105_3 from the RELOCATION_REQUIRED message 1, the GPRS network 101 sends a RELOCATION_REQUEST message 2 to the target RNC 105_3. The RELOCATION_REQUEST message 2 not only includes the RRC container but also includes bearer parameters (“RABs_to_be_Setup_List”) for the connection between the target RNC 105_3 and the GPRS core network 101 that will be used to service the roaming device in its new location. Here, when the core network 101 establishes a service for an end user device (e.g., voice call, web surfing session, etc.), a Radio Access Bearer (RAB) is setup for that service. A RAB includes certain parameters that effect the quality of service provided to the mobile device.

The target RNC 105_3 configures itself with the parameters contained in the RELOCATION_REQUEST message 2 and sends a RELOCATION_REQUEST_ACK message 3 back to the GPRS core network 101. The RELOCATION_REQUEST _ACK message 3 identifies the RAB(s) that have been setup for the device (“RABs_Setup_List”) as well as any RABs from the RABs_to_be_Setup_List that have not been setup for the device (“RABs_Failed_to_Setup_List”). Here, a RAB whose setup has failed can correspond to a lost aspect of the service provided to the device 107 as it moves into its new region 109. The RELOCATION_REQUEST_ACK message 3 may also include an RRC container that specifies new radio channels that the device 107 should switch to in the new region 109.

Upon receipt of the RELOCATION_REQUEST_ACK message 3, the GPRS core network 101 sends a RELOCATION_{—} COMMAND message 4 to the source RNC 105_2. The RELOCATION_{—} COMMAND message 4 contains a “RABs_to_be_Released_List” which is crafted from the difference between the RABs_Setup_List and the RABs_Failed_to_Setup_List from the ACK message 3. The RELOCATION_COMMAND message 4 also contains the RRC container having the new radio channel information within the RELOCATION_REQUEST_ACK message 3 if the ACK message 3 included an RRC container.

Upon receipt of the RELOCATION_COMMAND message 4 the source RNC 105_2 prepares the mobile device 107 for entry in the new region 109 by dropping the RABs that the new region 109 cannot support and sending the new radio channel information to the mobile device (if any). The source RNC 105_2 then releases from being the focal RNC for the mobile device's session with the service provider's network.

Notably, although an “inter-SGSN” roaming example was chosen for the example above (two SGSNs 102_1 and 102_N were involved in the example), “intra-SGSN” roaming may also follow the same procedure. Here, a same SGSN provides the behavior described above for the core network 101 and the source and target RNCs are serviced by the same SGSN.

Wireless service providers have begun to embrace the use of “offload” networks. FIG. 2 shows the network of FIG. 1 with the inclusion of an offload network. Often, an offload network is a cost effective wireless network (e.g., because it is public or free) that can be used to minimize congestion within the service provider's own network.

FIG. 2 shows the network of FIG. 1 adopted to include the ability to offload traffic to/from the end user devices through an offload network. Here, for example, if network 104 of FIG. 1 corresponds to the Internet, the offloading observed in FIG. 2 permits the end user devices' Internet traffic to bypass the GPRS core network 201 (e.g., so as not to swamp the GPRS core 201 with end user Internet traffic). Here, in order to effect such offloading for the end user Internet traffic of a particular RNC, an offload gateway is placed between the RNC and the GPRS core 101. As observed in FIG. 2, as an example, offload gateways 220_1 is observed between the GPRS core 201 and RNC 205_1. As such, in this arrangement, the end user Internet traffic of end user devices that are coupled to Node B 206_4 will bypass the GPRS network 201 and instead flow to/from the Internet 204 through offload gateways 220_1.

### FIGURES

The present invention is illustrated by way of example and not limitation in the figures of the accompanying drawings, in which like references indicate similar elements and in which:

FIG. 1 shows a prior art mobility process;

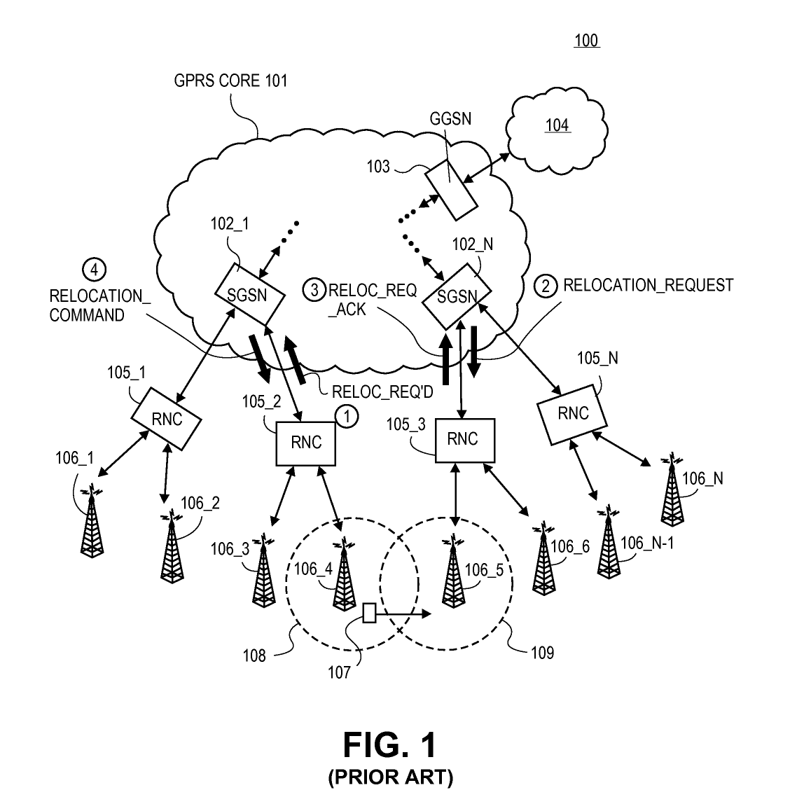

FIG. 2 shows a prior art architecture for offloading;

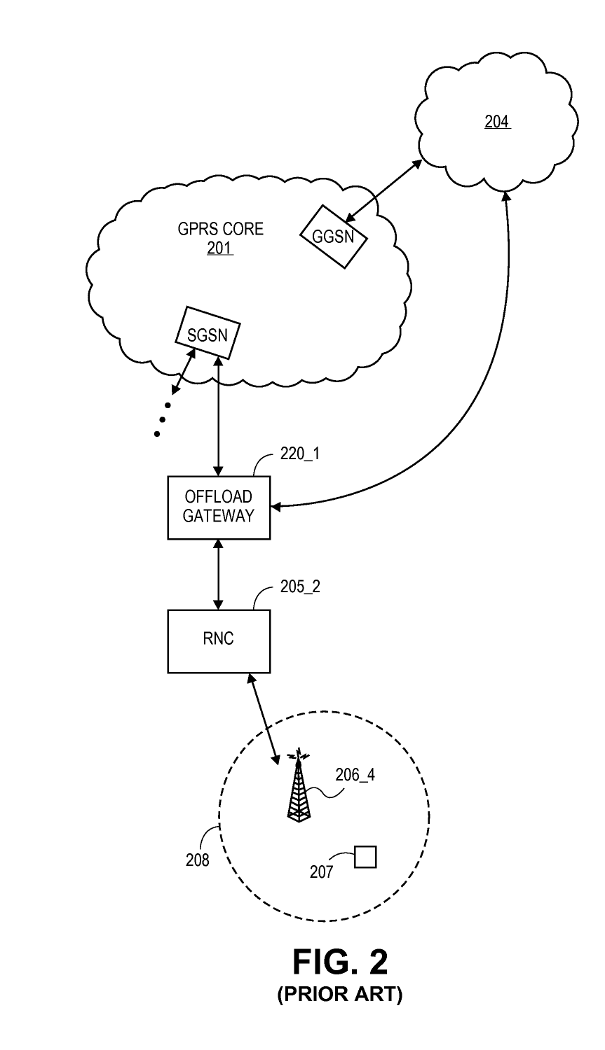

FIG. 3 shows an improved mobility process;

FIG. 4 shows a methodology performed by a source offload gateway;

FIG. 5 shows a methodology performed by a target offload gateway;

FIG. 6 shows an embodiment of an offload gateway having the functionality of FIGS. 3 and 4.

### DETAILED DESCRIPTION

With the acceptance of offload networks, a solution that permits roaming into different locations of the service provider's network while maintaining a same session within an offload network is needed.

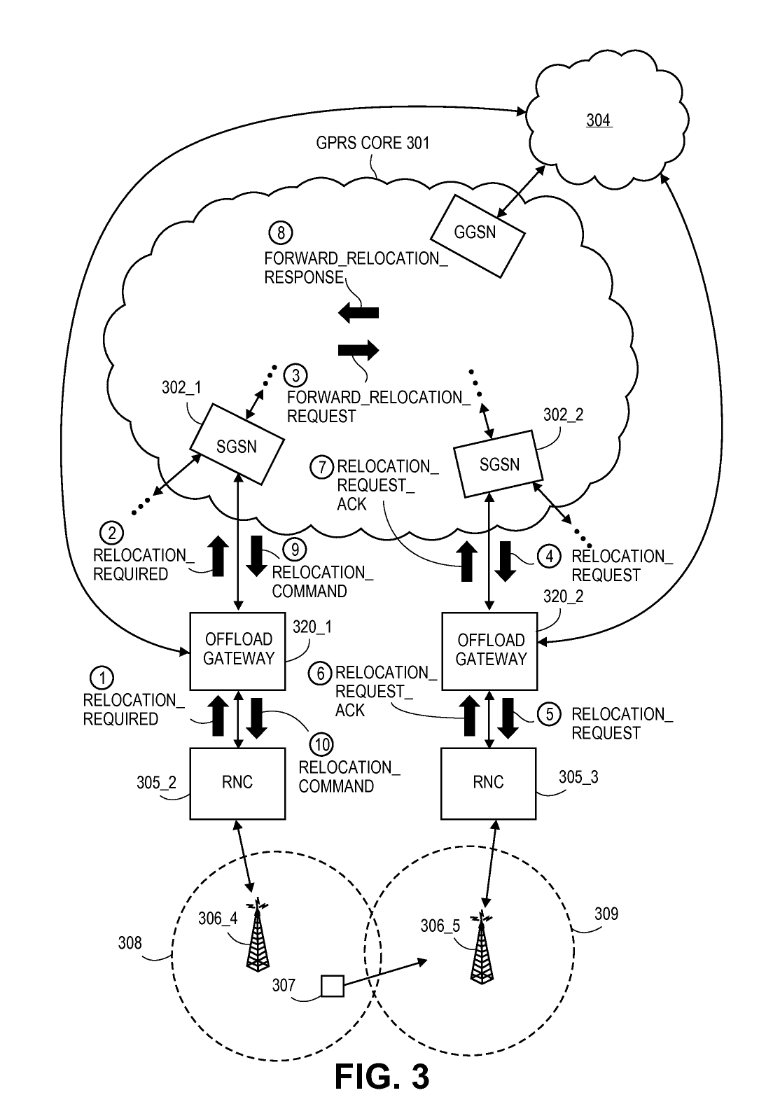

FIG. 3 shows a process in which a user device 307 roams from a region 308 associated with RNC 305_2 to a region 309 associated with RNC 305_3. Notably, however, the mobile device 307 is engaged in an offloaded session through offload gateway 320_1 to network 304 (which may be, for example, the Internet). Thus the challenge is to keep the session alive within network 304 while switching the recognized region of the device from the region 308 (covered by the source RNC 305_2) to the region 309 (covered by the target RNC 305_3). The movement of the device 307 from region 308 to region 309 is detected by RNC 305_2 (or RNC 305_2 is otherwise informed of the movement).

In response to recognizing the roaming of the device 307 into a new region 309, the source RNC 305_2 sends a sends a RELOCATION_REQUIRED message 1 to the offload gateway 320 _{—} 1 between the source RNC 305_2 and the GPRS core network 301. As described above, the RELOCATION REQUIRED message 1 essentially notifies the GPRS network 301 that a mobile device is leaving a region and needs to be associated with another region. The source RNC 305_2 can determine (or is told) the identity of the (“target”) RNC 305_3 for the region 309 that the mobile device is roaming into. As such, the RELOCATION_REQUIRED message 1 also includes the identity of the target RNC 305_3.

In an embodiment, the RELOCATION_REQUIRED message 1 also includes an RRC container which contains information that can be used by the target RNC 305_3 to provide seamless mobility to the end user. Here, in an embodiment, from the perspective of the source side, the source RNC 305_2 does not know whether or not the region being entered 309 supports offloading into the network 304 that the mobile device 307 currently has a session with.

The offload network gateway 320_1 receives the RELOCATION_REQUIRED message 1 and adds information to it for continuing the session in network 304 on the target side. In an embodiment, this information may include the respective IP address of one or more offloaded sessions for the mobile device 307, respective session IDs for sessions with network 304 that are to be seamlessly continued and offloaded NSAPIs information. Other information that is specific to the mobile device's session(s) with network 304 such as an offloaded gateway identity may also be included. In a further embodiment, the session specific information is added to an RRC container within a Source-RNC-to-Target-RNC-Transparent Container Information Element within the RELOCATION_REQUIRED message. In a further embodiment, the RRC container size is increased so that the source SGSN node 302_1 can transparently read this information and pass it to the target SGSN node 302_2. In an even further embodiment, besides the offload network session specific information, a “magic number” and a checksum is added to the RELOCATION REQUIRED message 1 by the offload network gateway 320_1 (e.g., within the RRC container along with the session specific information). Here, the magic number indicates where the session specific information is found within the message 1 and the checksum validates that the magic number does not collide with the RRC container's other information. The source offload gateway 320_1 then sends the RELOCATION_REQUIRED message with the added information 2 to the GPRS core network 301.

In one embodiment, the RELOCATION_REQUIRED message with added information 2 is sent by the source offload gateway 320_1 to the source SGSN node 302_1. The source SGSN node 302_1 in response, in the case of an inter-SGSN communication within the GPRS network, sends a FORWARD RELOCATION REQUEST message 3 with the added information (e.g., within the RRC container) to the “target” SGSN node 302_2. The FORWARD_RELOCATION_REQUEST message also includes the bearer parameters (“RABs_to_be_Setup_List”). The target SGSN node 302_2 then sends a RELOCATION_REQUEST message 4 to the “target” offload gateway 320_2 that resides between the core network 301 and the “target” RNC 305_2 (that services the region 309 that the mobile device 307 is entering).

The RELOCATION_REQUEST message 4 includes the session specific information carried by the RELOCATION_REQUIRED and FORWARD_RELOCATION_REQUEST messages 2,3 (e.g., within the RRC container). In an embodiment, the RELOCATION_REQUEST message 4 also includes the bearer parameters (“RABs_to_be_Setup_List”) associated with a traditional RELOCATION_REQUEST message.

Notably, in this particular example, the region 309 into which the mobile device 307 is moving into includes a gateway 320_2 to offload traffic to/from network 304. If the new region 309 did not include offloaded service into network 304 the target offload gateway 320_2 would not exist. In this case, the target RNC 305_3 would receive the RELOCATION_REQUEST message 4, ignore the session specific information added by the source offload gateway 320_1 and begin preparations for engaging the roaming device 307 through Node B 306_5 with the bearer parameters and RRC container found in the RELOCATION_REQUEST message 3.

In response to its reception of the RELOCATION_REQUEST message 4, the target offload gateway 320_2 obtains the offload session information within the message 3 and, in an embodiment, may remove it from the message 3. In a further embodiment, the target offload gateway 320_2 may reduce the size of RRC container so that the target RNC 305_3 receives the same RRC container and size as sent by the source RNC 305_2. The target offload gateway 320_2 then forwards the RELOCATION_REQUEST message 5 without the offloaded session information to the target RNC 305_3. The target RNC 305_3 configures itself with the standard 3GPP parameters contained in the RELOCATION_REQUEST message 5 and sends a RELOCATION_{—} REQUEST_{—} ACK message 6 to the target offload gateway 320_2. As in the standard 3GPP protocol, the RELOCATION_REQUEST_ACK message 6 identifies the RAB(s) that have been setup for the device (“RABs_Setup_List”) as well as any RABs from the RABs_to_be_Setup_List that have not been setup for the device (“RABs_Failed_to_Setup_List”). The RELOCATION_REQUEST_ACK message 6 may also include an RRC container that specifies new radio channels that the device 307 should switch to in the new region 309.

Upon its receipt of the RELOCATION_REQUEST_ACK message 6, the target offload gateway 320_2 adds information to the message that confirms the existence of the target offload gateway. Recall from above that, in an embodiment, the source side does not know whether or not a target offload gateway exists. As will be seen further below, the information added to the RELOCATION_REQUEST_ACK message 6 by the target offload gateway 320_2 will subsequently be used by the source offload gateway 320_1 to confirm the existence of the target offload gateway 320_2.

In an embodiment, in constructing the original RELOCATION_REQUEST_ACK message 6, the target RNC 305_3 may or may not include an RRC Container. If the RELOCATION_REQUEST_ACK message 6 prepared by the target RNC 305_3 includes an RRC container within a Target-RNC-to-Source-RNC-Transparent Container Information Element within RELOCATION_REQUEST_ACK message 6, the target offload gateway 320_2 adds the information that confirms its existence to the already existing RRC container and may also include the identity of the target offload gateway 320_2. In a further embodiment, the RRC container size is increased so that target SGSN node 302_2 can transparently read this information and pass it to the source SGSN node 302_1. In this case, in an even further embodiment, the added information includes a “magic number” and a checksum. Here, the magic number indicates where the added information is found within the RRC container and the checksum validates that the magic number does not collide with the RRC container's other information. If the original RELOCATION_REQUEST_ACK message 6 prepared by the target RNC 305_2 does not include an RRC container, the target offload gateway 320_2 adds an RRC container to the message 6 and includes the information that confirms its existence within the added RRC container and may also include the identity of the target offload gateway 320_2. In a further embodiment, the RRC container size is increased so that target SGSN node 302_2 can transparently read this information and pass it to the source SGSN node 302_1. In this case, in an even further embodiment, the added information includes a “magic number” and a checksum. Here, the magic number indicates where the added information is found within the RRC container and the checksum validates that the magic number does not collide with the RRC container's other information.

Thus, another RELOCATION_REQUEST_ACK message 7 having added information within an RRC container that confirms the existence of the target offload gateway 320_2 is sent by the target offload gateway 320_2 into the core GPRS network 301.

In an embodiment, the target offload gateway 320_2 sends the RELOCATION_{—} REQUEST_{—} ACK message 7 to the target SGSN 302_2. In response, again in the case of an inter-SGSN transfer, the target SGSN 302_2 sends a FORWARD RELOCATION RESPONSE message 8 to the source SGSN 302_1. The FORWARD RELOCATION RESPONSE message 8 includes the information added by the target offload gateway 305_2 that confirms its existence (and, e.g., resides within an RRC container) as well as the RABs_Setup_List and the RABs_Failed_to_Setup_List. The source SGSN 302_1, in response, sends a RELOCATION_COMMAND message 9 to the target offload gateway 320_1.

The RELOCATION_COMMAND message 9 contains a “RABs_to_be_Released_List” which is crafted from the difference between the RABs_Setup_List and the RABs_Failed_to_Setup_List from the FORWARD_RELOCATION_RESPONSE message 8. The RELOCATION_COMMAND message 9 also includes the RRC container that was included in the FORWARD_RELOCATION_RESPONSE message 8 that includes the information that confirms the existence of the target offload network gateway 320_2.

The source offload gateway 320_1 examines the RRC container in the RELOCATION_{—} COMMAND message 9 and determines whether or not the target offload gateway exists. In this example, the target offload gateway is found to exist. The source offload gateway 320_1 therefore understands that the mobile device's sessions within the network 304 can be maintained as it enters the new region 309. As such, no attempt is made to kill the mobile device's one or more sessions that the mobile device 307 is engaged with in network 304. By contrast, if the target offload gateway was found not to exist (e.g., because the RELOCATION_COMMAND message 9 did not include an RRC container or its RRC container did not contain information that confirmed the existence of the target offload gateway), the source offload gateway 320_1 would cause or otherwise permit the device's offloaded session with network 304 to be extinguished.

In either situation, in an embodiment, the source offload gateway 320_1 may remove the information that confirms the existence of the target offload gateway from the RELOCATION_COMMAND message 9 and sends a new RELOCATION COMMAND message 10 without this information to the source RNC 305_2. In a further embodiment, the source offload gateway 320_1 may reduce the size of RRC container so that source RNC 305_2 receives the same RRC container and size as sent by target RNC 305_3. The RABs identified in the RABs_to_be_Released_List are processed by the source RNC 305_2 and the mobile device 307 is prepared for entry into the new region 309 through communication with the Node B 306_5 controlled by the target RNC 305_3.

The session specific information effectively sent by the source offload gateway to the target offload gateway is used by the target offload gateway to continue the mobile device's session with network 304.

Although the above described process was described in reference to an inter-SGSN transfer, those of ordinary skill will recognize that the above procedure can also be readily extended to an intra-SGSN transfer. In this case, the mobile device roams from a source Node B to a target Node B whose respective RNCs are under the domain of the same SGSN node.

According to one approach, the SGSN node provides, from the perspective of the source offload gateway and the target offload gateway (or target RNC) the functionality of the GPRS network described above. That is, a single SGSN node accepts, from a source offload gateway, a RELOCATION_REQUIRED message with added session specific information. The same SGSN node then, in response, sends to a target offload gateway a RELOCATION_REQUEST message having the added session specific information. Likewise, the same SGSN receives, from the target offload gateway, a RELOCATION_REQUEST_ACK message having information that confirms the existence of the target offload gateway. The SGSN then sends, to the source offload gateway, a RELOCATION_COMMAND message having the information that confirms the existence of the offload gateway. The operation of the source and target offload gateways can remain the same as described above.

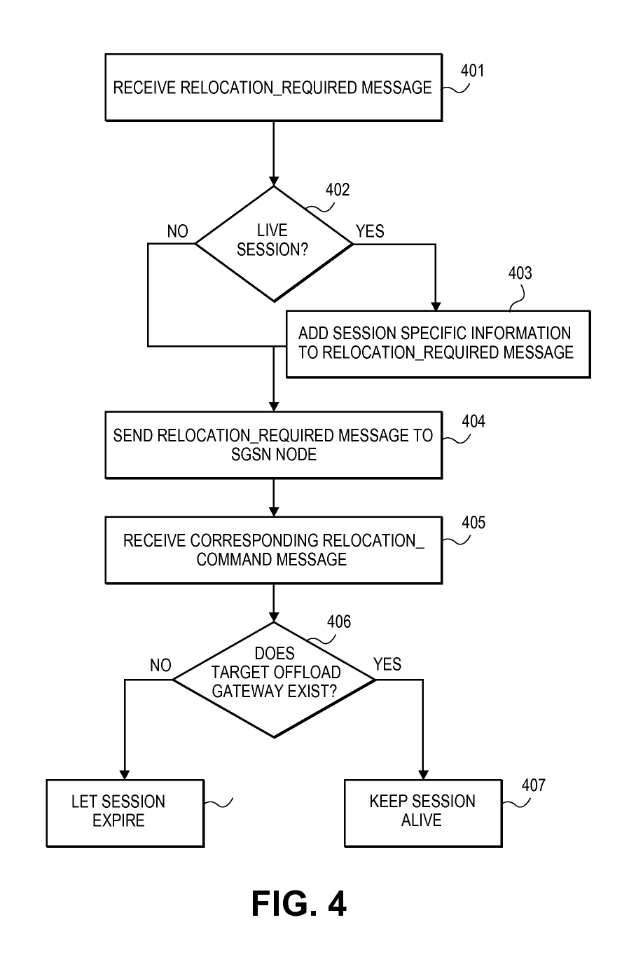

FIG. 4 shows a methodology performed by a source offload gateway. According to the process of FIG. 4, the source offload gateway receives a RELOCATION_REQUIRED message 401 from a source RNC, where, the RELOCATION_REQUIRED message was sent because a mobile device that is roaming out of the area of a Node B associated with the RNC that sent the RELOCATION_REQUIRED message. The source offload gateway recognizes 402 that it is currently supporting a live session for the roaming mobile device with a network that the source offload gateway provides offloaded network gateway services on behalf of. In response to the recognition 402, the source offload gateway adds 403 information specific to the session to the received RELOCATION REQUIRED message and sends 404 the RELOCATION_REQUIRED message with the added session specific information to an SGSN node within a GPRS network. In an embodiment, the session specific information is included within an RRC container. Upon receiving 405 a RELOCATION_COMMAND message in reference to the RELOCATION_REQUIRED message, the source offload gateway inquires to see if the RELOCATION_COMMAND includes information that confirms the existence of a target offload gateway. If so, the target offload gateway keeps the session alive 407 or otherwise attempts to prevent its expiration.

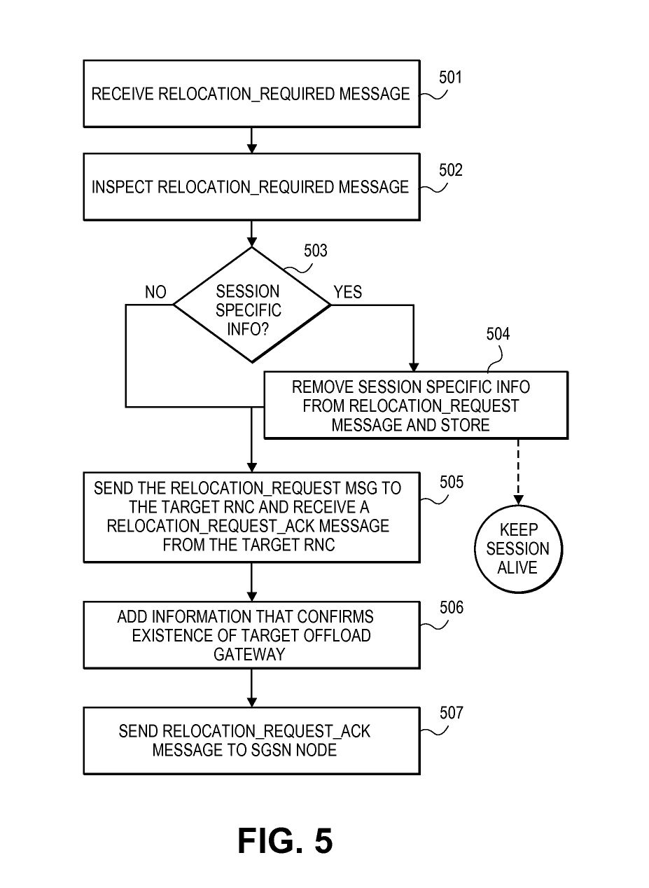

FIG. 5 shows a methodology performed by a target offload gateway. According to the process of FIG. 5, the target offload gateway receives 501 a RELOCATION_REQUEST message from an SGSN node within a GPRS network. The target offload gateway inspects 502 the RELOCATION_{—} REQUEST message to see if it includes session specific information for a live session of a roaming device that is roaming into a region of an RNC to which the RELOCATION REQUEST message is directed. If the RELOCATION_REQUEST message includes the session specific information 503, the target offload gateway removes 504 the information from the message and keeps the session specific information (e.g., by storing it in an internal memory) to preserve the mobile device's session with a network that the target offload gateway provides offload gateway services on behalf of. The target offload gateway then forwards 505 the RELOCATION_REQUEST message without the session specific information to the RNC to which the RELOCATION_REQUEST message is directed 505. In response to its reception 505 of a RELOCATION_REQUEST_ACK message (pertaining to the RELOCATION REQUEST message) from the RNC, the target offload gateway adds 506 information to the RELOCATION_REQUEST_ACK message that confirms the existence of the target offload gateway. In an embodiment the information is added to an RRC container. In a further embodiment, the target offload gateway adds an RRC container to the ACK message if the received ACK message does not include one. The target offload gateway then forwards 507 the RELOCATION_REQUEST_ACK message with the added information to the SGSN node.

Notably, whether an offload network gateway is a source offload network gateway or a target offload network gateway depends on its positioning in the network relative to a roaming device. Specifically, if a roaming device is roaming out of the area of an RNC that the offload network gateway supports the offload network gateway is a source offload network gateway. Likewise, if the roaming device is roaming into an area of an RNC that the offload network gateway supports the offload network gateway is a target offload network gateway. As such a single offload network gateway can be either a source or target and therefore should have source and target functionality. Therefore a single offload network gateway should have the functionality of both FIGS. 4 and 5 above.

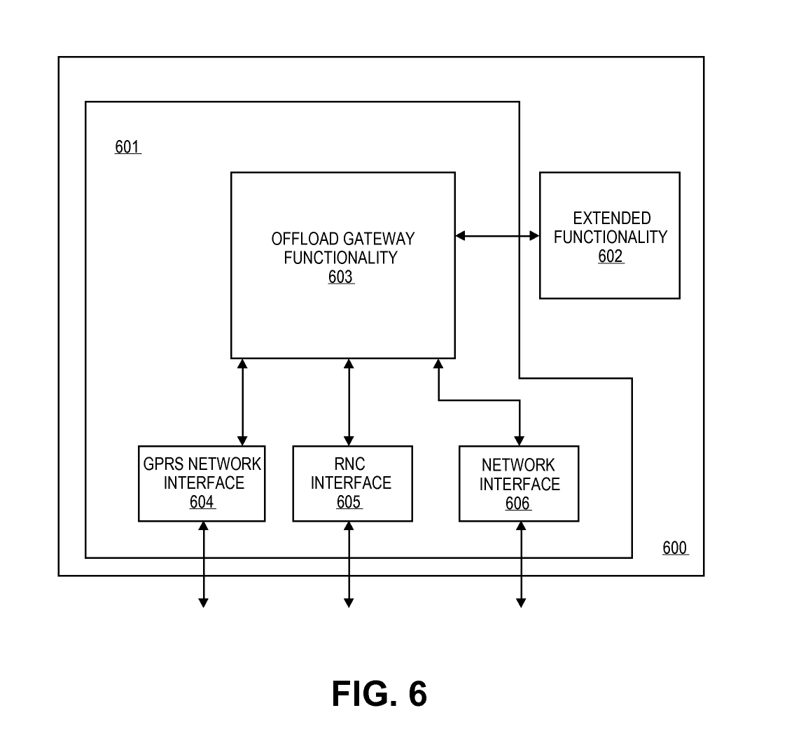

FIG. 6 shows an architecture for an offload network gateway 600 that is designed according to these principles. Specifically, the offload network gateway includes a traditional functionality portion 601 and an extended functionality portion 602. The traditional functionality portion 601 includes an interface 604 to a GPRS network, an interface 605 to an RNC, an interface to a network 606 that the gateway provides gateway services for in order to provide offloaded gateway services, and, a traditional offload gateway services function 603. The traditional offload gateway services function 603 may include: i) the forwarding of RELOCATION_{—} REQUEST messages from the GPRS network interface 604 to the RNC interface 605; ii) the forwarding of RELOCATION_REQUEST_ACK messages from the RNC interface 605 to the GPRS network interface 604; iii) the sending of (inbound/from mobile device) data traffic from the RNC interface 605 to the network interface 606; and, iv) the sending of (outbound/to mobile device) data traffic from the network interface 606 to the RNC interface 605.

The extended functionality portion 602 includes functionalities consistent with those described in FIGS. 4 and 5 so that the offload network gateway can provide for seamless roaming for devices engaged in an offloaded sessions. Here, it is pertinent to point out that any of the functions, traditional or extended, may be implemented in hardware, software or various combinations thereof. In the case of hardware, as just a few options, custom designed semiconductor chips may be utilized (programmable logic or hardwired logic for example). In the case of software, program code may be processed by a processing unit (such as an embedded processor or microprocessor).

As such, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, Fortran, Pascal, Perl, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.) or may be compiled directly into object code.

According to various approaches the abstract execution environment may convert the intermediate form program code into processor specific code by, 1) compiling the intermediate form program code (e.g., at run-time (e.g., a JIT compiler)), 2) interpreting the intermediate form program code, or 3) a combination of compiling the intermediate form program code at run-time and interpreting the intermediate form program code. Abstract execution environments may run on various operating systems (such as UNIX, LINUX, Microsoft operating systems including the Windows family, Apple Computers operating systems including MacOS X, Sun/Solaris, OS/2, Novell, etc.).\

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
performing the following at an offload network gateway:
receiving a RELOCATION_REQUIRED message from an RNC;
recognizing that said RELOCATION_REQUIRED message pertains to a roaming device having a live session with a network that said offload network gateway acts as a gateway to in order to offload data traffic from a GPRS network; and,
adding information specific to said session to said RELOCATION_REQUIRED message.

2. The method of claim 1 further comprising performing the following at said offload network gateway:
sending said RELOCATION_REQUIRED message with said added information to an SGSN node.

3. The method of claim 2 further comprising performing the following at said offload network gateway:
receiving a RELOCATION_COMMAND message that pertains to said RELOCATION_REQUIRED message; and,
inspecting said RELOCATION_COMMAND message for information that confirms the existence of a target offload gateway.

4. The method of claim 3 further comprising performing either of the following at said offload network gateway:
in response to said information that confirms the existence of said target offload gateway being found in said RELOCATION_COMMAND message, keeping said session alive;
in response to said information that confirms the existence of said target offload gateway not being found in said RELOCATION_COMMAND message, permitting said session to be extinguished.

5. The method of claim 4 where said information that confirms the existence of said target offload gateway is found in said RELOCATION_COMMAND message within an RRC container of said RELOCATION_COMMAND message.

6. The method of claim 1 wherein said information that is specific to said session is added to said RELOCATION_REQUIRED message within an RRC container of said RELOCATION_REQUIRED message.

7. A method, comprising:
performing the following at an offload network gateway:
receiving a RELOCATION_REQUEST message;
inspecting said RELOCATION_REQUEST message for information specific to a roaming device's live session with a network that said offload network gateway acts as a gateway to in order to offload data traffic from a GPRS network;
in response to identifying said information within said RELOCATION_REQUEST message, extracting said information and using said information to continue the session for the roaming device.

8. The method of claim 7 further comprising removing said information from said RELOCATION_REQUEST message and forwarding said RELOCATION_REQUEST message without said information to a target RNC.

9. The method of claim 7 further comprising:
receiving a RELOCATION_REQUEST_ACK message that pertains to said RELOCATION_REQUEST message;
adding information to said RELOCATION_REQUEST_ACK message that confirms the existence of said offload network gateway; and, sending said RELOCATION_REQUEST_ACK message with the information that confirms the existence of said offload network gateway to an SGSN.

10. The method of claim 9 wherein said information that confirms the existence of said offload network gateway is placed within an RRC container of said RELOCATION_REQUEST_ACK message.

11. The method of claim 10 wherein said network offload gateway adds said RRC container to said RELOCATION_REQUEST_ACK message if said received RELOCATION_REQUEST_ACK message does not include an RRC container.

12. An offload network gateway, comprising:
a) an interface to a GPRS network;
b) an interface to an RNC;
c) an interface to a network that said offload network gateway acts as a gateway to offload traffic from said GPRS network;
d) a source offload network gateway extended functional portion to perform the following method:
receiving a RELOCATION_REQUIRED message from a source RNC;
recognizing that said RELOCATION_REQUIRED message pertains to a roaming device having a live session with said network; and,
adding information specific to said session to said RELOCATION_REQUIRED message;
e) a target offload network gateway extended functional portion to perform the following method:
receiving a RELOCATION_REQUEST message from said GPRS network;
inspecting said RELOCATION_REQUEST message for information specific to a second roaming device's live respective session with said network;
in response to identifying said information within said RELOCATION_REQUEST message, extracting said information and using said information to continue the session for the roaming device.

13. The offload gateway of claim 12 wherein said source offload network gateway extended functional portion is to further perform the following:
sending said RELOCATION_REQUIRED message with said added information to an SGSN node.

14. The offload gateway of claim 13 wherein said source offload network gateway extended functional portion is to further perform the following:
receiving a RELOCATION_COMMAND message that pertains to said RELOCATION_REQUIRED message; and,
inspecting said RELOCATION_COMMAND message for information that confirms the existence of a target offload gateway.

15. The offload gateway of claim 12 wherein said target offload network gateway extended functional portion is to further perform the following:
removing said information from said RELOCATION_REQUEST message and forwarding said RELOCATION_REQUEST message without said information to a target RNC.

16. The offload gateway of claim 15 wherein said target offload network gateway extended functional portion is to further perform the following:
receiving a RELOCATION_REQUEST_ACK message that pertains to said RELOCATION_REQUEST message;
adding information to said RELOCATION_REQUEST_ACK message that confirms the existence of said offload network gateway; and,
sending said RELOCATION_REQUEST_ACK message with the information that confirms the existence of said offload network gateway to an SGSN.

17. A machine readable containing stored program code that when processed by a processing unit within an offload network gateway causes the network offload gateway to perform a method, said method comprising:
receiving a RELOCATION_REQUIRED message from an RNC;
recognizing that said RELOCATION_REQUIRED message pertains to a roaming device having a live session with a network that said offload network gateway acts as a gateway to in order to offload data traffic from a GPRS network; and, adding information specific to said session to said RELOCATION_REQUIRED message.

18. A machine readable containing stored program code that when processed by a processing unit within an offload network gateway causes the network offload gateway to perform a method, said method comprising:
receiving a RELOCATION _REQUEST message;
inspecting said RELOCATION_REQUEST message for information specific to a roaming device's live session with a network that said offload network gateway acts as a gateway to in order to offload data traffic from a GPRS network;
in response to identifying said information within said RELOCATION_REQUEST message, extracting said information and using said information to continue the session for the roaming device.
